(19) United States
(12) Patent Application Publication
(10) Pub. No.: US 2015/0076047 A1
(43) Pub. Date: Mar. 19, 2015

(54) Particle Processing Device Using Combination of Multiple Membrane Structures

(71) Applicant: KOREA ADVANCED INSTITUTE OF SCIENCE AND TECHNOLOGY, Yuseong-gu, Daejeon (KR)

(72) Inventors: Young-Ho Cho, Daejeon (KR); Il Doh, Daejeon (KR)

(73) Assignee: KOREA ADVANCED INSTITUTE OF SCIENCE AND TECHNOLOGY, Daejoen (KR)

(21) Appl. No.: 14/391,913

(22) PCT Filed: Apr. 10, 2013
(86) PCT No.: PCT/KR2013/002993

§ 371 Date: Oct. 10, 2014

(30) Foreign Application Priority Data
Apr. 12, 2012 (KR) 10-2012-0037670

(51) Int. Cl. B01D 29/56; B01D 29/60

(52) U.S. Cl. CPC B01D 29/56; B01D 29/60
USPC 210/137; 210/335

(57) ABSTRACT

A particle processing device includes a fluid flow path, a multi-filtering portion and a fluid transferring portion. A fluid having particles flows through the fluid flow path. The multi-filtering portion is installed in the fluid flow path. The multi-filtering portion includes at least two membrane structures. The membrane structures have different shaped openings for passing the fluid therethrough respectively. The membrane structures are arranged alone or together in the fluid flow path. The fluid transferring portion transfers the fluid forwardly or backwardly through the fluid flow path such that the fluid passes through the multi-filtering portion.

### CLAIM OF PRIORITY

This application claims priority under 35 USC §119 to Korean Patent Application No. 2012-0037670, filed on Apr. 12, 2012 in the Korean Intellectual Property Office (KIPO), the contents of which are herein incorporated by reference in their entirety.

### BACKGROUND

1. Field

Example embodiments relate to a particle processing device. More particularly, example embodiments relate to a particle processing device for performing multiple functions of capturing, collecting, counting and analyzing a particle in a fluid.

2. Description of the Related Art

Generally, one of technologies of detecting and capturing a micro-particle in a fluid may use a single filter layer for filtering out the particle from the fluid. However, in order to collect, count and analyze the filtered particles, additional filtering and analyzing structures and a fluid transfer therebetween may be required. During these processes, many problems such as losses of the particles may occur.

### SUMMARY

Example embodiments provide a particle processing device for various functions such as sorting, counting, collecting and analyzing particles in a single analyzing device. According to example embodiments, a particle processing device includes a fluid flow path, a multi-filtering portion and a fluid transferring portion. A fluid having particles flows through the fluid flow path. The multi-filtering portion is installed in the fluid flow path. The multi-filtering portion includes at least two membrane structures. The membrane structures have different shaped openings for passing the fluid therethrough respectively. The membrane structures are arranged alone or together in the fluid flow path. The fluid transferring portion transfers the fluid forwardly or backwardly through the fluid flow path such that the fluid passes through the multi-filtering portion.

In example embodiments, the membrane structure of the multi-filtering portion may be detachably installed in the fluid flow path.

In example embodiments, the multi-filtering portion may include a first membrane structure and a second membrane structure. The first membrane structure may include a first opening of a first size and the second membrane structure may include a second opening of a second size different from the first size. The first size of the first opening may be smaller than a diameter of the particle and the second size of the second opening may be greater than the diameter of the particle.

In example embodiments, the multi-filtering portion may further include a third membrane structure. The third membrane structure may be detachably installed in the fluid flow path. The third membrane structure may include a third opening of a third size different from the first size. The third size of the third opening may be smaller than the first size.

In example embodiments, the third membrane structure may be installed in the fluid flow path, after the first membrane structure is removed from the fluid flow path.

In example embodiments, at least one of the membrane structures may include an electrode pattern for counting the number of the particles which pass through the opening.

In example embodiments, the multi-filtering portion may include a cylindrical fastening member for installing the membrane structure in the fluid flow path.

In example embodiments, a conductive pattern may be formed on a side surface of the cylindrical fastening member to be electrically connected to the electrode pattern

In example embodiments, the cylindrical fastening member may have a truncated conic shape.

In example embodiments, a thread groove may be formed on an inner surface or an outer surface of the cylindrical fastening member.

In example embodiments, the fluid may include blood, bodily fluid, cerebrospinal fluid, urine and spectrum collected from human or animal. These may be used alone or in a mixture thereof.

In example embodiments, the particle may include tissue, cell, protein and nucleic acid collected from human or animal. These may be used alone or in a mixture thereof.

In example embodiments, the effective diameter of the opening may range from about 1 μm to about 50 μm.

In example embodiments, the openings of the membrane structure may be arranged in a matrix form. The occupying area of the openings may range from about 5% to about 50% of the whole area of the membrane structure.

In example embodiments, the flow rate or direction of the fluid flowing through the multi-filtering portion in the fluid flow path may be controlled by a centrifugal force or an agitating force.

In example embodiments, the membrane structure may include at least two filter layers that are arranged to be overlapped with each other, the filter layers may have holes respectively that form the opening, and a shape and a size of the opening may be controlled.

According to example embodiments, a particle processing device may include a multi-filtering portion having at least two membrane structures which are arranged in a fluid flow path. The particle processing device may efficiently capture, collect, count and analyze particles by using bidirectional flow in the fluid flow path.

### BRIEF DESCRIPTION OF THE DRAWINGS

Example embodiments will be more clearly understood from the following detailed description taken in conjunction with the accompanying drawings. FIGS. 1 to 9 represent non-limiting, example embodiments as described herein.

FIG. 1 is a view illustrating a particle processing device in accordance with example embodiments.

FIG. 2A is a cross-sectional view illustrating a first membrane structure in the particle processing device in FIG. 1.

FIG. 2B is a perspective view illustrating a portion of the first membrane structure in FIG. 2A.

FIG. 2C is a plan view illustrating the first membrane structure in FIG. 2A.

FIG. 3A is a cross-sectional view illustrating a second membrane structure in the particle processing device in FIG. 1.

FIG. 3B is a perspective view illustrating a portion of the second membrane structure in FIG. 3A.

FIG. 4A is a cross-sectional view illustrating a third membrane structure in the particle processing device in FIG. 1.

FIG. 4B is a perspective view illustrating a portion of the third membrane structure in FIG. 4A.

FIGS. 5A to 5F are cross-sectional views illustrating a sidewall of an opening of the membrane structure in FIG. 2A.

FIGS. 6A to 6C are plan views illustrating a modification of the membrane structure in FIG. 2A.

FIGS. 7A to 7D are cross-sectional views illustrating a method of processing a particle using a combination of the membrane structures of the particle processing device in FIG. 1.

FIG. 8A is a perspective view illustrating the membrane structure in FIG. 7A.

FIG. 8B is a perspective view illustrating the membrane structures in FIG. 7B.

FIG. 8C is a perspective view illustrating the membrane structures in FIG. 7C.

FIG. 9 is a perspective view illustrating the membrane structure in FIG. 7A.

### DESCRIPTION OF EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

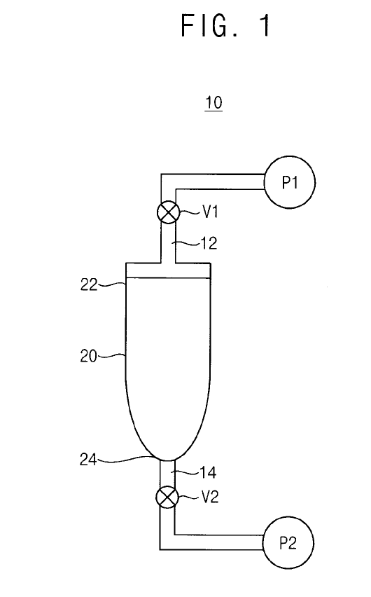

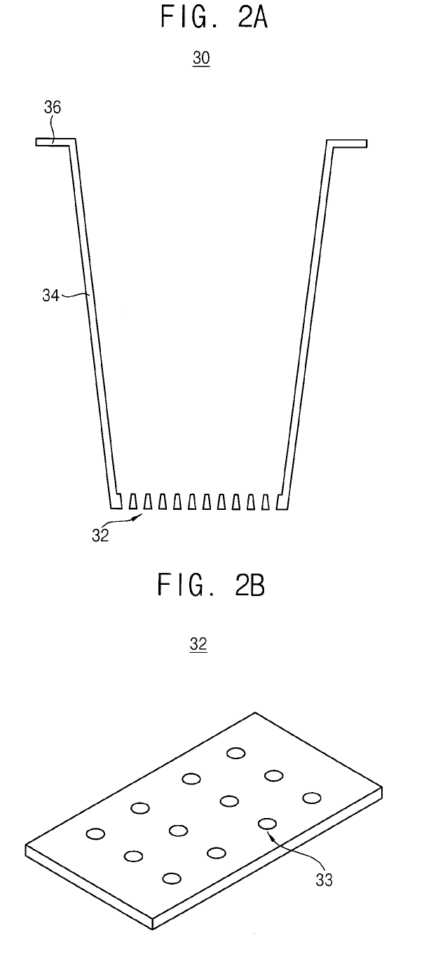

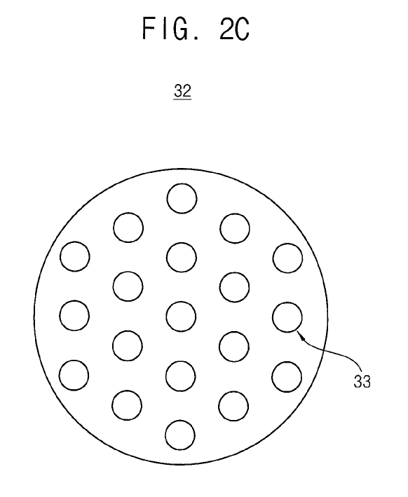

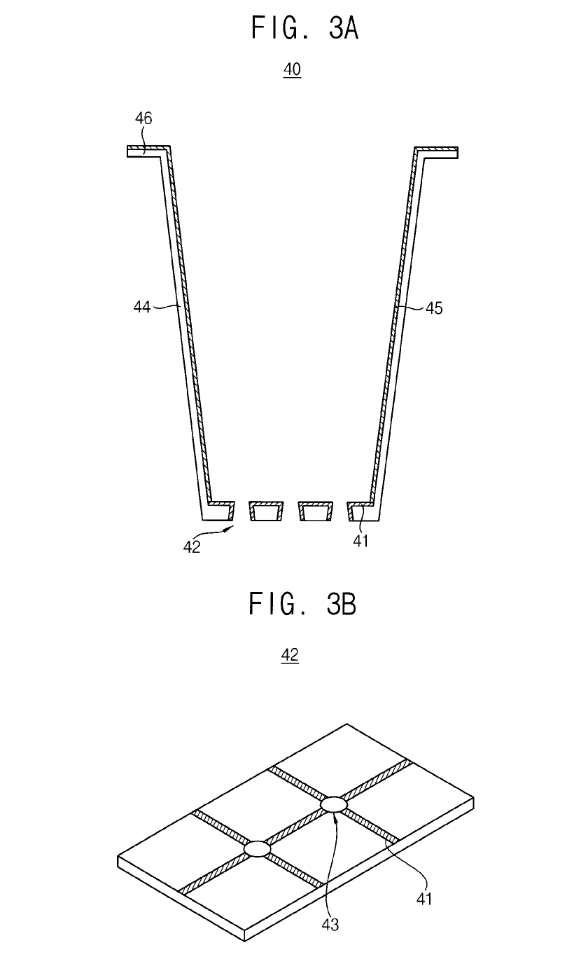

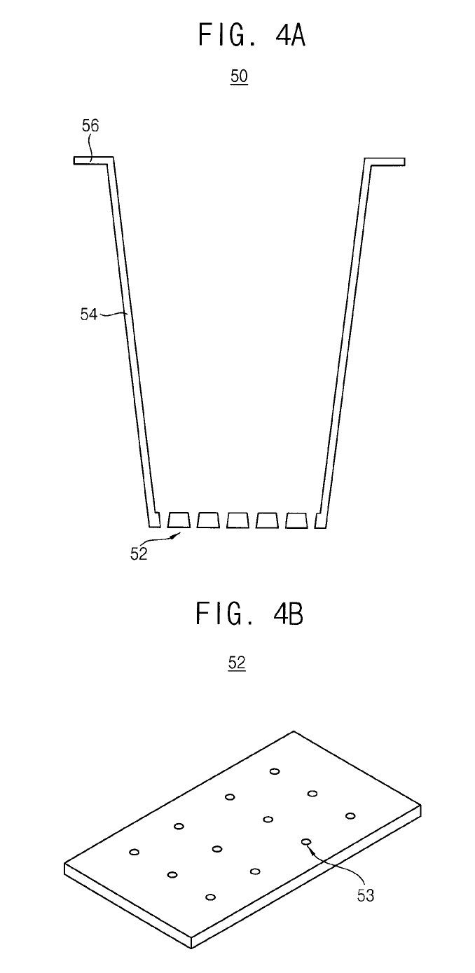

FIG. 1 is a view illustrating a particle processing device in accordance with example embodiments. FIG. 2A is a cross-sectional view illustrating a first membrane structure in the particle processing device in FIG. 1. FIG. 2B is a perspective view illustrating a portion of the first membrane structure in FIG. 2A. FIG. 2C is a plan view illustrating the first membrane structure in FIG. 2A. FIG. 3A is a cross-sectional view illustrating a second membrane structure in the particle processing device in FIG. 1. FIG. 3B is a perspective view illustrating a portion of the second membrane structure in FIG. 3A. FIG. 4A is a cross-sectional view illustrating a third membrane structure in the particle processing device in FIG. 1. FIG. 4B is a perspective view illustrating a portion of the third membrane structure in FIG. 4A.

Referring to FIGS. 1 to 4B, a particle processing device 10 according to example embodiments may include a fluid flow path 20 for providing a space for fluid flow, a multi-filtering portion arranged in the fluid flow path 20, and a fluid transferring portion for transferring a fluid forwardly or backwardly through the fluid flow path 20.

In example embodiments, the fluid transferring portion may include a first pump P1 and a second pump P2. The first pump P1 may be connected to a first connection flow path 12 via a first valve V1, and the first connection flow path 12 may be connected to a first end portion 22 of the fluid flow path 20. The second pump P2 may be connected to a second connection flow path 14 via a second valve V2, and the second connection flow path 14 may be connected to a second end portion 24 of the fluid flow path 20.

The first valve V1 may be connected to a first fluid supply portion (not illustrated), and a fluid may be supplied from the first fluid supply portion to the first end portion 22 of the fluid flow path 20 by the first pump P1. The second valve V2 may be connected to a second fluid supply portion (not illustrated), and a fluid may be supplied from the second supply portion to the second end portion 24 of the fluid flow path 20 by the second pump P2. For example, the first pump and the second pump may operate on the basis of mechanical principles (e.g. external syringe pumps, pneumatic membrane pumps, vibrating membrane pumps, vacuum devices), electrical or magnetic principles (e.g. electrohydrodynamic pumps, magenetohydrodynamic pumps), thermodynamic principles, etc.

Accordingly, the fluid transferring portion may transfer a fluid in a first direction (forwardly) from the first end portion 22 of the fluid flow path 20 to the second end portion portion 24 of the fluid flow path 20. Additionally, the fluid transferring portion may transfer a fluid in a second direction (backwardly) from the second end portion 24 to the first end portion 22.

In another example embodiment, a separation container for centrifugation or agitation may be used to function as the fluid flow path 20. In this ease, the separation container used for the fluid flow path 20 may include a cylindrical tube, which contains the fluid therein. The separation container may be connected to a fluid transferring portion such as a rotor of a centrifuge or an agitating means of an agitator such that the separation container may rotate or move in curved trajectories to separate desired particles in the fluid flow path 20.

Accordingly, the fluid transferring portion may rotate or agitate the separation container such that the fluid may flow bidirectionally (forwardly or backwardly) along the fluid flow path 20. Thus, the flow rate or direction of the fluid flowing through the multi-filtering portion in the fluid flow path 20 may be controlled by a centrifugal force or an agitating force.

For example, the fluid may be a bodily fluid such as blood including cells of different types and biological particles. The fluid may include a target particle having information about the health of an organism. The target particle may be a biological micro-particle such as cancer cell, bacteria, virus, etc.

In particular, the fluid collected from human or animal sample may include blood, bodily fluid, cerebrospinal fluid, urine, spectrum, a mixture thereof, a diluted solution thereof, etc. The particle in the fluid may include tissue, cell, protein, nucleic acid, a mixture thereof.

The multi-filtering portion may include at least two membrane structures which have different shaped openings for filtering the fluid respectively. The two membrane structures may be arranged alone or together in the fluid flow path 20 to perform at least one of separating, collecting and counting particles.

In example embodiments, the multi-filtering portion may include a first filter structure 30, a second filter structure 40 and a third filter structure 50 which are detachably installed in the fluid flow path 20. The first to third filter structures may be arranged alone or together in the fluid flow path 20.

As illustrated in FIGS. 2A to 2C, the first filter structure 30 may include a first membrane structure 32 and a first cylindrical fastening member 34 for installing the first membrane structure 32 in the fluid flow path 20. The first cylindrical fastening member 34 may include a connection portion 36, which is fixed to the first end portion 22 of the fluid flow path 20.

In example embodiments, the first membrane structure 32 may include a plurality of first openings 33 for filtering the fluid. For example, a diameter of the first opening 33 may have a first size smaller than a diameter of a target particle. The first cylindrical fastening member 34 may have a truncated conic shape. The inner area of the first cylindrical fastening member 34 may be gradually decreased in a forward direction along the fluid flow path 20.

For example, the effective diameter of the first opening may range from about 1 μm to about 50 μm. The first openings may be arranged in a matrix form. The occupying area of the first openings may range from about 5% to about 50% of the whole area of the first membrane structure 32.

As illustrated in FIGS. 3A to 3B, the second filter structure 40 may include 30 may include a second membrane structure 42 and a second cylindrical fastening member 44 for installing the second membrane structure 42 in the fluid flow path 20. The second cylindrical fastening member 44 may include a connection portion 46, which is fixed to the first end portion 22 of the fluid flow path 20.

In example embodiments, the second membrane structure 42 may include a plurality of second openings 43 for filtering the fluid. The second opening 43 may have a different shape from the first opening 33. For example, a diameter of the second opening 43 may have a second size greater than the diameter of the target particle.

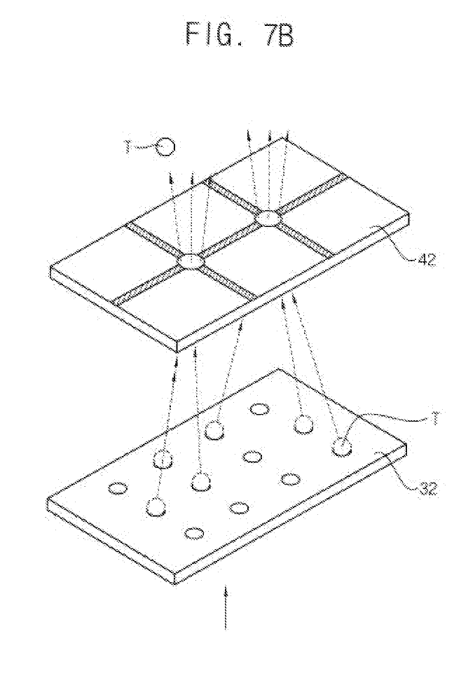

The second cylindrical fastening member 44 may have a truncated conic shape. The inner area of the second cylindrical fastening member 44 may be gradually decreased in a forward direction along the fluid flow path 20. Accordingly, the first cylindrical fastening member 34 and the second cylindrical fastening member 44 may be inserted with interference fit into each other such that the first membrane structure 32 and the second membrane structure 42 may be arranged to be spaced apart from each other (See FIG. 7B). For example, the second membrane structure 42 may be installed in front of the first membrane structure 32, that is, upstream in the fluid flow path 20.

In example embodiments, the second membrane structure 42 may include an electrode pattern 41 for counting the number of the particles which pass through the second opening 43. The electrode pattern 41 may be formed on the second member structure 42 to surround the second opening 43. The electrode pattern 41 may have various shapes for counting the number of the particles which pass through the second opening 43.

The electrode pattern 41 may be electrically connected to a conductive pattern 45 on the second cylindrical fastening member 44. Accordingly, the electrode pattern 41 may be electrically connected to an external device such as a counter (not illustrated) through the conductive pattern 45.

As illustrated in FIGS. 4A and 4B, the third filter structure 50 may include a third membrane structure 52 and a third cylindrical fastening member 54 for installing the third membrane structure 52 in the fluid flow path 20.

In example embodiments, the third membrane structure 52 may include a plurality of third openings 53 for filtering the fluid. For example, a diameter of the third opening 53 may have a third size smaller than the first size.

The third cylindrical fastening member 54 may have a truncated conic shape. The inner area of the third cylindrical fastening member 54 may be gradually decreased in a forward direction along the fluid flow path 20. Accordingly, the first to third cylindrical fastening members may be inserted with interference fit. For example, the third membrane structure 52 may be installed in the fluid flow path 20 instead of the first membrane structure 32. That is, after the first membrane structure 32 is removed, the third membrane structure 52 may be installed in rear of the second membrane structure 42, that is, downstream in the fluid flow path 20.

In example embodiments, a biochemical material layer may be coated on the cylindrical fastening member of the multi-filtering portion or surface treatment may be performed on the cylindrical fastening member, in order to increase or decrease the adhesive strength with the particle.

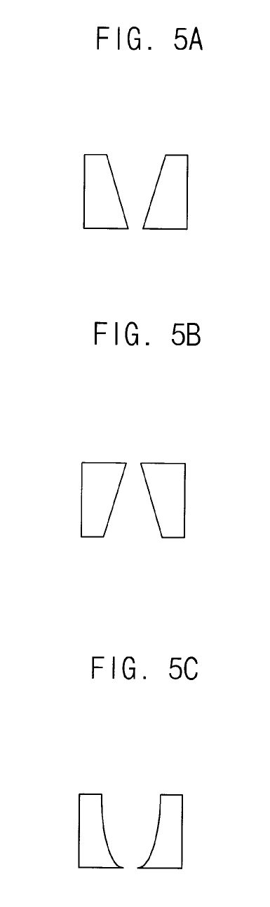

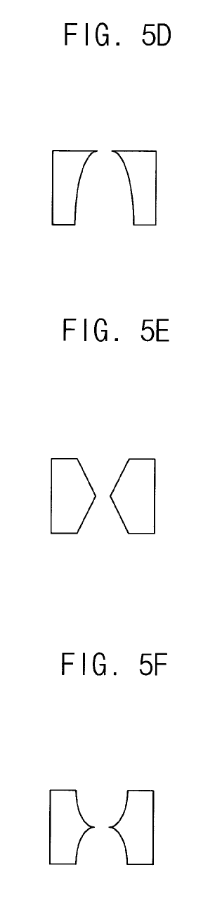

FIGS. 5A to 5F are cross-sectional views illustrating a sidewall of an opening of the membrane structure in FIG. 2A.

Referring to FIG. 5A to 5F, the opening formed in the membrane structure may have various profiles. As illustrated in FIGS. 5A and 5B, the sidewall profile of the opening may have a linear shape. As illustrated in FIGS. 5C and 5D, the sidewall profile of the opening may have a curved shape. As illustrated in FIGS. 5E and 5F, the middle portion of the opening may have a relatively smaller diameter. Alternatively, the opening may have a constant diameter in an extending direction of the opening.

Although it is not illustrated in the figures, the opening of the membrane structure may have various shapes. As seen in plan view, the opening may have a circular or polygonal shape.

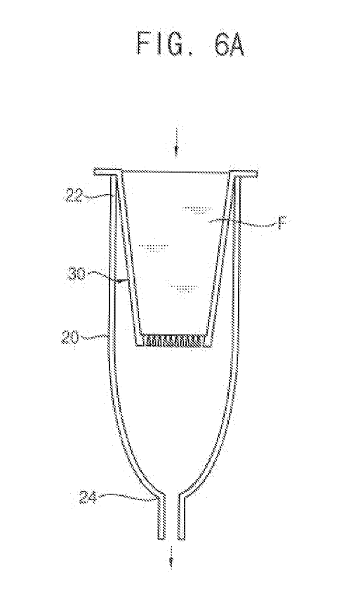

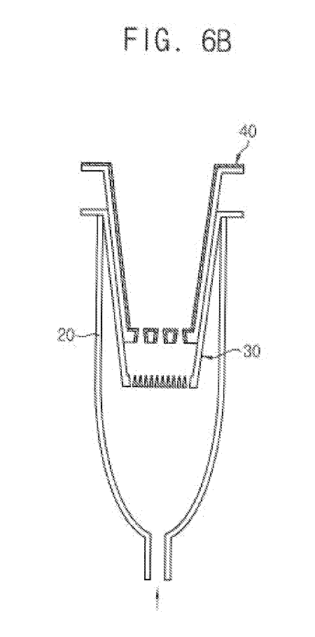

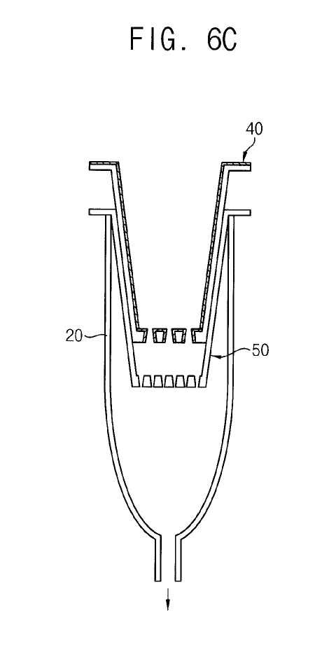

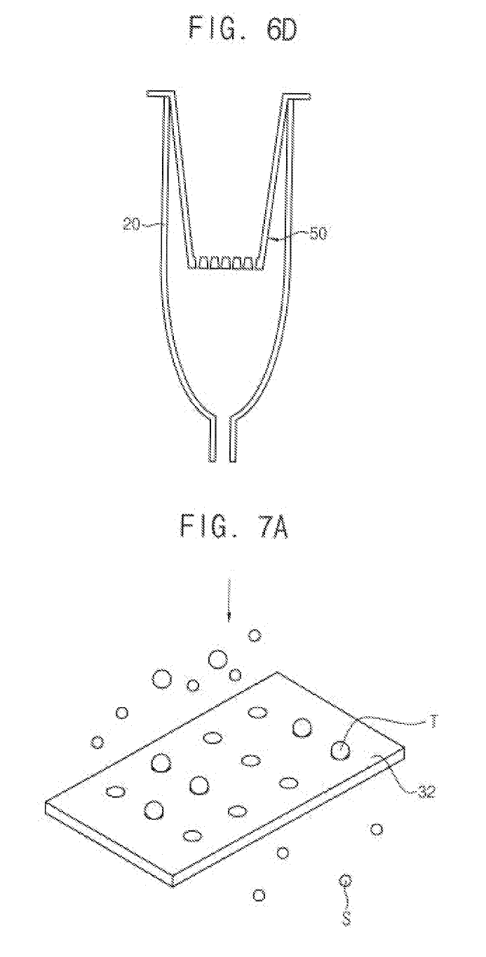

FIGS. 6A to 6C are plan views illustrating a modification of the membrane structure in FIG. 2A.

Referring to FIGS. 6A to 6C, a first membrane structure 32 may include at least two filter layers that are arranged to be overlapped with each other. The first membrane structure 32 may include a first filter layer 34a and a second filter layer 34b. The first filter layer 34a may include a plurality of first holes 36a and the second filter layer 36b may include a plurality of second holes 36b. The first filter layer 34a and the second filter layer 34b may be arranged to be overlapped with each other.

As illustrated in FIGS. 6B and 6C, the first and second filter layers 34a and 34b may move (translate or rotate) relatively to each other to control the size of the first openings 33 that are formed by the first and second holes 36a and 35b. Accordingly, the first membrane structure 32 may serve as a filter for selectively passing a particle in fluid. Although it is illustrated in the figures, the second and third membrane structures 42 and 52 may include filter layers that are arranged to be overlapped with each other to control the size and the area of the opening.

Hereinafter, a method of collecting a particle from a fluid using the particle processing device in FIG. 1 will be explained.

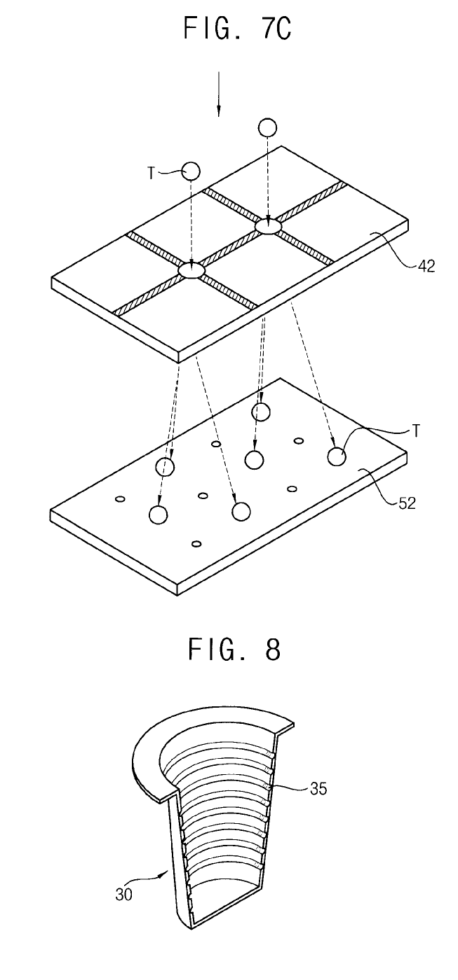

FIGS. 7A to 7D are cross-sectional views illustrating a method of processing a particle using a combination of the membrane structures of the particle processing device in FIG. 1. FIG. 8A is a perspective view illustrating the membrane structure in FIG. 7A. FIG. 8B is a perspective view illustrating the membrane structures in FIG. 7B. FIG. 8C is a perspective view illustrating the membrane structures in FIG. 7C. FIG. 9 is a perspective view illustrating the membrane structure in FIG. 7A.

Referring to FIGS. 7A and 8A, after a first filter structure 30 is installed in a fluid flow path 20, a fluid F may flow in a first direction (forward direction) from a first end portion 22 of the fluid flow path 20 to a second end portion 24 of the fluid flow path 20 by a fluid transferring portion such that the fluid F may pass through a first membrane structure 32 of the first filter structure 30.

A diameter of a first opening 33 of the first membrane structure 32 may have a first size smaller than a diameter of a micro-particle T. Accordingly, the first membrane structure 32 may filter out the micro-particle T from the fluid F. Particles having a diameter smaller than the first size may pass through the first membrane structure 32.

Referring to FIGS. 7B and 8B, a second filler structure 40 may be installed in the fluid flow path 20. The first and second filter structures 30 and 40 may have a truncated conic shape. As illustrated in FIG. 9, a thread groove may be formed on an inner surface of a first cylindrical fastening member 34 of the first filter structure 30 and a thread may be formed on an outer surface of a second cylindrical fastening member 44 of the second filter structure 40 to be inserted into the thread groove. Alternatively, a thread groove may be formed on the outer surface of the second cylindrical fastening member 44 of the second filter structure 40 and the thread may be formed on the inner surface of the first cylindrical fastening member 34 of the first filter structure 30.

Accordingly, the second cylindrical fastening member 44 of the second filter structure 40 may be inserted with interference fit into the first cylindrical fastening member 34 of the first filter structure 30 such that the first membrane structure 32 and the second membrane structure 42 may be arranged in the fluid flow path 20 to he spaced apart from each other. For example, the second membrane structure 42 may be installed in front of the first membrane structure 32, that is, downstream of the fluid flow.

The fluid transferring portion may change a flow direction and transfer a fluid in a second direction (backward direction) opposite to the first direction from the second end portion 24 of the fluid flow path 20 to the first end portion 22 such that the fluid may pass through the first membrane structure 32 of the first filter structure 30 and the second membrane structure 42 of the second filter structure 40.

A diameter of a second opening 43 of the second membrane structure 42 may have a second size greater than the diameter of the micro-particle T. The second membrane structure 42 may include an electrode pattern 41 for counting the number of the micro-particles T passing through the second opening 43. The electrode pattern 41 may be formed to surround the second opening 43. Accordingly, the second membrane structure 42 may be used to count and analyze the micro-particles.

Referring to FIGS. 7C and 8C, a third filter structure 50 may be installed in the fluid flow path 20. The third filter structure 50 may be installed in the fluid flow path 20 instead of the first filter structure 30. Accordingly, after the first membrane structure 32 is removed, a third membrane structure 52 may be installed in rear of the second membrane structure 42, that is, upstream of the fluid flow.

The fluid transferring portion may change a flow direction again and transfer a fluid in the first direction (forward direction) from the first end portion 22 of the fluid flow path 20 to the second end portion 24 such that the fluid may pass through the second membrane structure 42 of the second filter structure 40 and the third membrane structure 52 of the third filter structure 50.

The third membrane structure 52 may include a plurality of third openings 53 for filtering the fluid. For example, a diameter of the third opening 53 may have a third size smaller than the first size of the first opening 32. Accordingly, the micro-particle T may be filtered out to remain on the third membrane structure 52.

Referring to FIG. 7D, the second filter structure 40 may be removed from the fluid flow path 20 and the micro-particles T filtered by the third filter structure 50 may be collected.

As mentioned above, a particle processing device according to example embodiments may perform various functions such as sorting, counting, collecting and analyzing particles from a fluid using a combination of the different membrane structures.

At least two membrane structures and a combination thereof may be used to provide a particle processing device where various functions of sorting, counting, collecting and analyzing particles may be performed in one device, thereby minimizing loss of micro-particles and miniaturizing the entire analyzation system.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A particle processing device, comprising:
a fluid flow path through which a fluid having particles flows;
a multi-filtering portion installed in the fluid flow path and including at least two membrane structures, the membrane structures having different shaped openings for passing the fluid therethrough respectively, the membrane structures being arranged alone or together in the fluid flow path; and
a fluid transferring portion for transferring the fluid forwardly or backwardly through the fluid flow path such that the fluid passes through the multi-filtering portion.

2. The particle processing device of claim 1, wherein the membrane structure of the multi-filtering portion is detachably installed in the fluid flow path.

3. The particle processing device of claim 1, wherein the multi-filtering portion comprises a first membrane structure and a second membrane structure, the first membrane structure includes a first opening of a first size and the second membrane structure includes a second opening of a second size different from the first size.

4. The particle processing device of claim 3, wherein the first size of the first opening is smaller than a diameter of the particle and the second size of the second opening is greater than the diameter of the particle.

5. The particle processing device of claim 3, wherein the multi-filtering portion further comprises a third membrane structure, the third membrane structure being detachably installed in the fluid flow path, the third membrane structure including a third opening of a third size different from the first size.

6. The particle processing device of claim 5, wherein the third size of the third opening is smaller than the first size.

7. The particle processing device of claim 5, wherein the third membrane structure is installed in the fluid flow path, after the first membrane structure is removed from the fluid flow path.

8. The particle processing device of claim 1, wherein at least one of the membrane structures comprises an electrode pattern for counting the number of the particles which pass through the opening.

9. The particle processing device of claim 8, wherein the multi-filtering portion comprises a cylindrical fastening member for installing the membrane structure in the fluid flow path.

10. The particle processing device of claim 9, wherein a conductive pattern is formed on a side surface of the cylindrical fastening member to be electrically connected to the electrode pattern

11. The particle processing device of claim 8, wherein the cylindrical fastening member has a truncated conic shape.

12. The particle processing device of claim 8, wherein a thread groove is formed on an inner surface or an outer surface of the cylindrical fastening member.

13. The particle processing device of claim 1, wherein the fluid comprises at least one selected from the group consisting of blood, bodily fluid, cerebrospinal fluid, urine and spectrum collected from human or animal.

14. The particle processing device of claim 1, wherein the particle comprises at least one selected from the group consisting of tissue, cell, protein and nucleic acid collected from human or animal.

15. The particle processing device of claim 1, wherein the effective diameter of the opening ranges from about 1 μm to about 50 μm.

16. The particle processing device of claim 1, wherein the openings of the membrane structure are arranged in a matrix form.

17. The particle processing device of claim 16, wherein the occupying area of the openings ranges from about 5% to about 50% of the whole area of the membrane structure.

18. The particle processing device of claim 1, wherein the flow rate or direction of the fluid flowing through the multi-filtering portion in the fluid flow path is controlled by a centrifugal force or an agitating force.

19. The particle processing device of claim 1, wherein the membrane structure comprises at least two filter layers that are arranged to be overlapped with each other, the filter layers have holes respectively that form the opening, and a shape and a size of the opening is controlled.
